(19) United States
(12) Patent Application Publication
(10) Pub. No.: US 2009/0191967 A1
(43) Pub. Date: Jul. 30, 2009

(54) GAME APPARATUS AND CONTROLLER

(75) Inventors: Ryo Konishi, Shiga (JP); Tatsuya Uno, Shiga (JP)

Correspondence Address: JEROME D. JACKSON (JACKSON PATENT LAW OFFICE), 211 N. UNION STREET, SUITE 100, ALEXANDRIA, VA, 22314, US

(73) Assignee: SSD COMPANY LIMITED, KUSATSU-CITY SHIGA (JP)

(21) Appl. No.: 11/816,112

(22) PCT Filed: Feb. 15, 2006
(86) PCT No.: PCT/JP2006/303103

§ 371 Date: Sep. 25, 2007

(30) Foreign Application Priority Data
Feb. 17, 2005 (JP) 2005-040439

(51) Int. Cl. G06F 17/00; A63F 9/24

(52) U.S. Cl. 463/37

(57) ABSTRACT

The game apparatus 1 includes a circuit housing member 17 which incorporates a tilt sensor 46 for detecting the tilt of the game apparatus 1, a ROM 50 for storing a game program and image and sound data, and a processor 48 for performing various types of arithmetic operations and generating a video signal and an audio signal. A left grip 13 and a right grip 15 are provided on both sides of the circuit housing member 17 respectively. A player 11 grips the grips 13 and 15 and moves the game apparatus 1 in air. The processor 48 changes a manipulation object 88 displayed on a television monitor 7 in accordance with the tilt of the game apparatus 1.

### TECHNICAL FIELD

The present invention relates to a game apparatus including a tilt sensor and the related arts.

### BACKGROUND ART

A motorcycle game controller is disclosed in Japanese Patent Published Application No. 2002-113264. This controller includes a base member having a flat bottom surface such that it can be stably placed on a floor and the like, a steering axis member provided upward from the base member, a handlebar member provided on the top of the steering axis member in the form of a mock of the steering bar of a motorcycle, and a chassis member located under the handlebar member, fixed to the steering axis member and shaped in the form resembling the cowling and fuel tank of a motorcycle. The size of the controller is such that it can be fitted inside a rectangular parallelepiped having each side of about 30 cm.

Then, the user connects this controller with a game apparatus through a cable, and connects the game apparatus with a television monitor through a cable such that the motorcycle game can be played by manipulating the controller while watching a game screen displayed on the television monitor.

However, since this conventional controller is designed on the assumption that it is placed on a floor, dynamic operations are not supported. Namely, the controller is not designed to make it possible to manipulate it while freely lifting and moving it.

### DISCLOSURE OF INVENTION

It is therefore an object of the present invention to provide a game apparatus and the related arts having dynamic operability.

In accordance with an aspect of the present invention, a game apparatus to be moved in air, comprises: a tilt detection unit operable to detect a tilt of the game apparatus; a housing member in which said tilt detection unit is provided; a first cylindrical grip member to be gripped by one hand of a player; and a second cylindrical grip member to be gripped by the other hand of the player, wherein said first grip section and said second grip section are located respectively on the opposite sides of said housing member.

In accordance with this configuration, since the game apparatus itself is moved in air while the tilt of the game apparatus is detected, it is possible to develop game programs which make use of the tilt of the game apparatus itself. Accordingly, the player can enjoy the game while performing dynamic manipulations.

In this case, the tilt detection unit may be any one of a variety of sensors capable of detecting tilts, such as a tilt sensor, an accelerating sensor and a gyro sensor. The above game apparatus further comprises a processor operable to change a manipulation object to be displayed on a display device in accordance with the tilt of the game apparatus as detected by said tilt detection unit, wherein said processor is located in said housing member.

In accordance with this configuration, since the processor is provided, the game can be played only by connecting the game apparatus with the display device.

The above game apparatus is provided with a battery box in at least one of said first grip section and said second grip section.

In accordance with this configuration, since the space can be effectively utilized, it is possible to optimize the size of the game apparatus. The optimized size is such that the player can move the game apparatus in air in a comfortable manner.

In accordance with the above game apparatus, said tilt detection unit comprises four switches which are used for detecting the tilts of the game apparatus to the left, to the right, downward to the front and upward to the front respectively.

In accordance with another aspect of the present invention, a controller to be moved in air and operable to output a control signal to an information processing apparatus which generates an image to be displayed on a display device, comprises: a tilt detection unit operable to detect a tilt of the controller and output a signal indicative of the tilt to the information processing apparatus as the control signal; a housing member in which said tilt detection unit is provided; and a grip portion attached to the housing member or integrated with the housing member, and provided to be gripped by a hand of a player.

In accordance with this configuration, since the controller itself is moved in air while the tilt of the controller is detected, it is possible to generate an image reflecting the tilt of the controller itself. Accordingly, the player can enjoy the image reflecting the tilt of the controller while performing dynamic manipulations.

In this case, the tilt detection unit may be any one of a variety of sensors capable of detecting tilts, such as a tilt sensor, an accelerating sensor and a gyro sensor.

### BRIEF DESCRIPTION OF DRAWINGS

The novel features of the invention are set forth in the appended claims. The invention itself, however, as well as other features and advantages thereof, will be best understood by reading the detailed description of specific embodiments in conjunction with the accompanying drawings, wherein:

FIG. 1 is a block diagram for showing the entire configuration of a game system in accordance with an embodiment of the present invention.

FIG. 2 is a perspective view for showing the game apparatus 1 of FIG. 1.

FIG. 3 is an explanatory schematic diagram for showing the internal configuration of the game apparatus 1 of FIG. 2.

FIG. 4 is an enlarged view for showing the right lever 21 of FIG. 3 and its peripheral portion.

FIG. 5 is a diagram for showing the electric configuration of the game apparatus 1 of FIG. 2.

FIG. 6 is a view showing an example of a game mode selection screen (race/stunt) as displayed on the television monitor 7 of FIG. 1.

FIG. 7 is a view for showing an example of a game mode selection screen (stage A/B/C) as displayed on the television monitor 7 of FIG. 1.

FIG. 8 is a view for showing an example of a game screen as displayed on the television monitor 7 of FIG. 1.

FIG. 9 is a flow chart for showing an example of the game process by the processor 48 of FIG. 5.

FIG. 10 is an explanatory view of a three dimensional coordinate system for explaining the tilt sensor 46 of FIG. 5.

### BEST MODE FOR CARRYING OUT THE INVENTION

In what follows, an embodiment of the present invention will be explained in conjunction with the accompanying drawings. Meanwhile, like references indicate the same or functionally similar elements throughout the respective drawings, and therefore redundant explanation is not repeated.

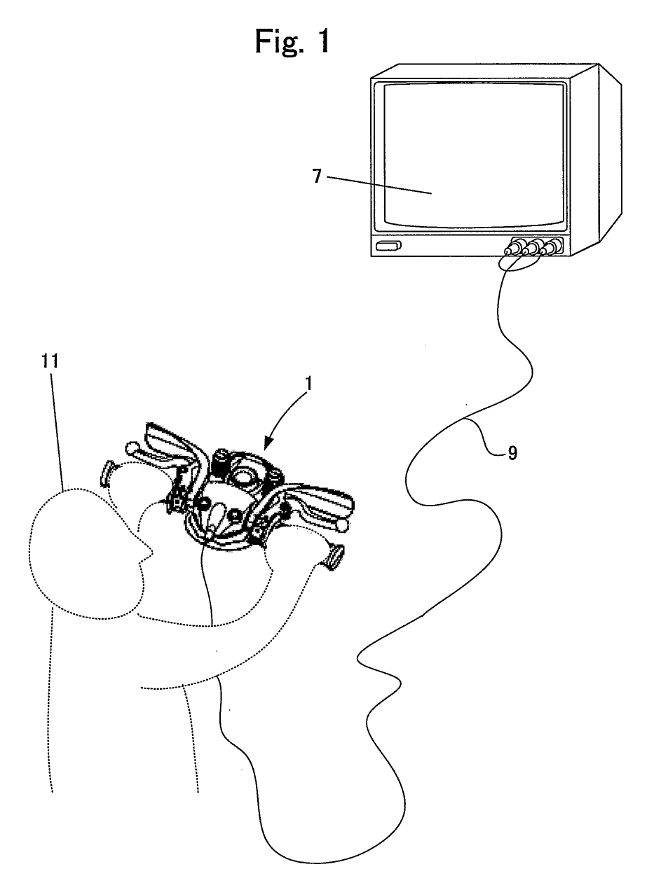

FIG. 1 is a block diagram for showing the entire configuration of a game system in accordance with the embodiment of the present invention. As shown in FIG. 1, this game system is provided with a game apparatus 1 and a television monitor 7. The game apparatus 1 is connected to the television monitor 7 by an AV cable 9. Furthermore, although not shown in the figure, the game apparatus 1 is supplied with a power supply voltage from an AC adapter or a battery.

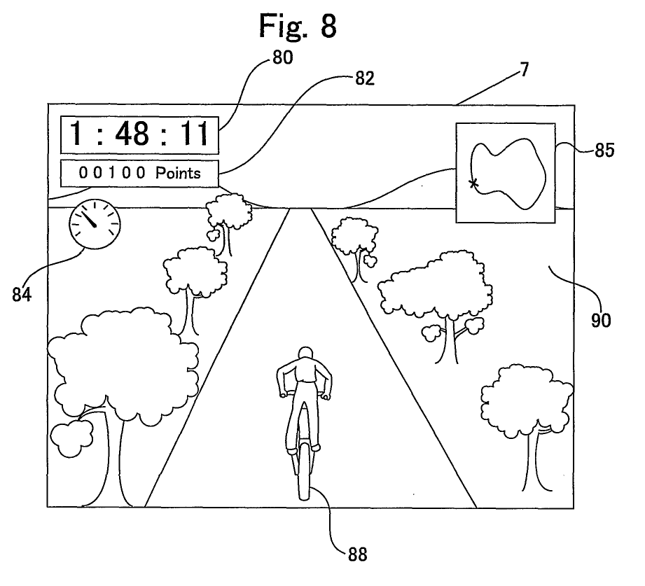

In this example of the present embodiment, since the game apparatus 1 is used to play a motocross game, the appearance of the game apparatus 1 is designed to resemble the handlebar of a motorcycle. A player 11 can play the motocross game by holding this handlebar-type game apparatus 1, and then tilting it to the right (with a right grip 15 oriented downward and a left grip 13 oriented upward), tilting it to the left (with a right grip 15 oriented upward and a left grip 13 oriented downward), tilting it downward to the front or tilting it upward to the front in order to manipulate a manipulation object 88 (refer to FIG. 8 to be described below) displayed on the television monitor 7.

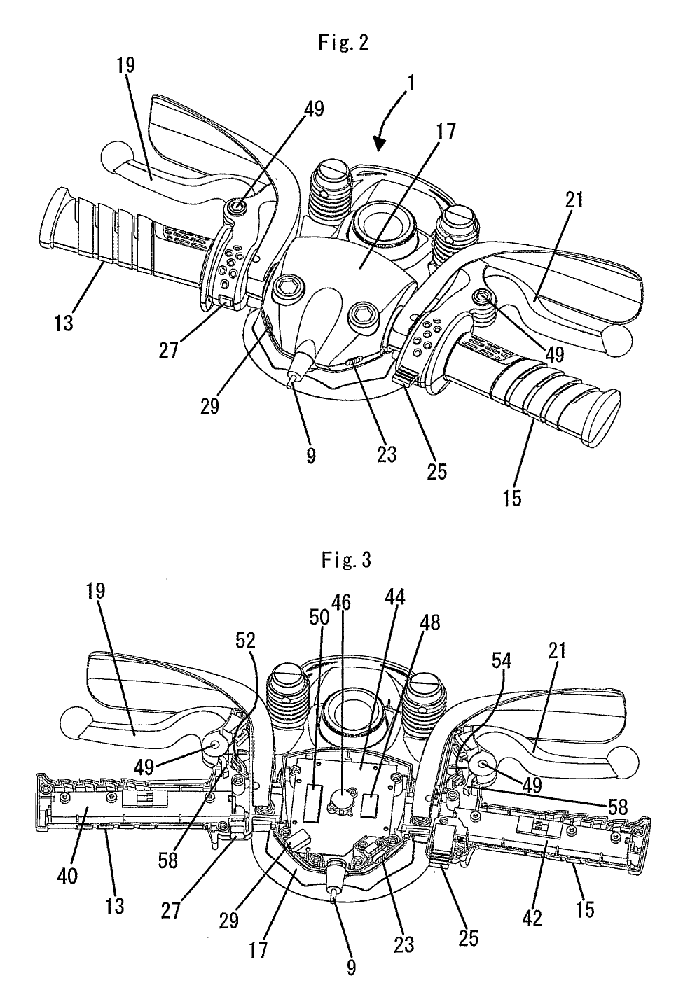

FIG. 2 is a perspective view for showing the game apparatus 1 of FIG. 1. As shown in FIG. 2, this game apparatus 1 includes the cylindrical left grip 13, a left lever 19, the cylindrical right grip 15, a right lever 21 and a circuit housing member 17. The left grip 13 and the right grip 15 are formed on the left and right sides of the circuit housing member 17. The base end of the left grip 13 is provided with a pause switch 27 for pausing the screen, and the base end of the right grip 15 is provided with an accelerator switch 25 for accelerating the manipulation object 88 of the screen. In addition to this, the circuit housing member 17 is provided with a DC jack 29 near the left grip 13 and a power supply switch 23 near the right grip 15.

The left lever 19 is located in correspondence with the left grip 13. If the player 11 pulls the left lever 19, a left brake switch 52 to be described below is turned on. On the other hand, the right lever 21 is located in correspondence with the right grip 15. If the player 11 pulls the right lever 21, a right brake switch 54 to be described below is turned on.

FIG. 3 is an explanatory schematic diagram for showing the internal configuration of the game apparatus 1 of FIG. 2. FIG. 3 illustrates the left grip 13, the right grip 15 and the circuit housing member 17 from which their upper housings are removed respectively.

As shown in FIG. 3, battery boxes 40 and 42 are provided inside the left grip 13 and the right grip 15 respectively. Two AA type battery cells are set in each of the battery boxes 40 and 42. A substrate 44 is mounted on the circuit housing member 17. In this substrate 44, a variety of circuit elements such as a tilt sensor 46, a processor 48 and a ROM (read only memory) are mounted.

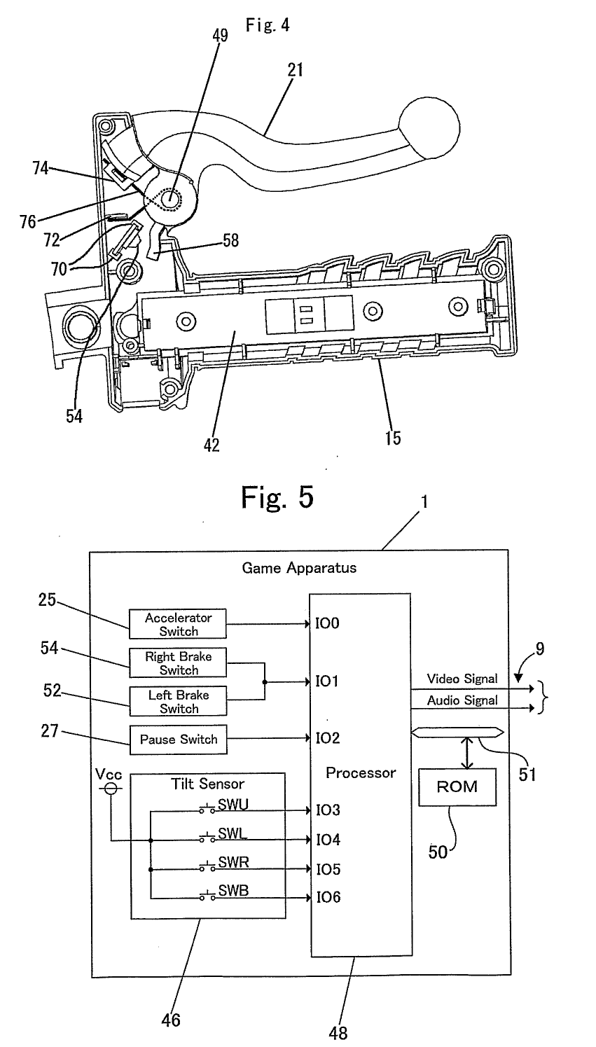

FIG. 4 is an enlarged view for showing the right lever 21 of FIG. 3 and its peripheral portion. As illustrated in FIG. 4, the socket 70 is provided near the base end of the right lever 21, and the right brake switch 54 is mounted on this socket 70. By this configuration, the right brake switch 54 is vertically arranged in an upright position on the internal bottom surface of the game apparatus 1.

A torsion spring 76 is fitted onto a rotation axis 49 of the base end of the right lever 21. One end of this torsion spring 76 comes in contact with a receiving section 74 which is provided at the base end of the right lever 21, and thereby a force is exerted on the right lever 21 to rotate it in the counter clockwise direction. On the other hand, the other end of the torsion spring 76 comes in contact with a receiving section 72 which is provided in an upright position on the internal bottom surface of the game apparatus 1, and thereby a force is exerted on the receiving section 72 to rotate it in the clockwise direction. Accordingly, the right lever 21 is urged to its home position by the elastic force of the torsion spring 76.

On the other hand, a push member 58 is formed on the base end of the right lever 21. When the player 11 pulls the right lever 21 such that the right lever 21 is rotated about the rotation axis 49 (in the clockwise direction), the push member 58 is also rotated together therewith (in the clockwise direction). Then, the right brake switch 54 is pushed and turned on with this push member 58. On the other hand, when the player 11 releases the right lever 21, the right lever 21 returns to the home position by the elastic force of the torsion spring 76, and the right brake switch 54 is turned off.

Meanwhile, the left lever 19 and its peripheral portion have the similar structure and functions as the right lever 21 and its peripheral, and therefore no redundant description is repeated.

FIG. 5 is a diagram for showing the electric configuration of the game apparatus 1 of FIG. 2. As shown in FIG. 5, the game apparatus 1 includes a processor 48, a ROM 50, a bus 51, the accelerator switch 25, the right brake switch 54, the left brake switch 52, the pause switch 27 and the tilt sensor 46.

The processors 48 and the ROM 50 are connected to the bus 51. One contact of the accelerator switch 25 and one contact of the pause switch 27 are connected respectively to input/output ports IO0 and IO2 of the processor 48. One contact of the right brake switch 54 and one contact of the left brake switch 52 are connected at a connection point, which is connected to an input/output port IO1 of the processor 48.

FIG. 5 shows an equivalent circuit representing the electric configuration of the tilt sensor 46 in which one contact of a switch SWU, one contact of a switch SWL, one contact of a switch SWR and one contact of a switch SWB are connected respectively to the input/output ports IO3, IO4, IO5 and IO6 of the processor 48.

The accelerator switch 25, the pause switch 27, the right brake switch 54, the left brake switch 52 and the other contacts of the switch SWU, the switch SWL, the switch SWR and the switch SWB are supplied with a power supply voltage Vcc.

The tilt sensor 46 is a tilt detection sensor which detects the tilt of the game apparatus 1. In what follows, this will be explained in detail. In this description, the detection of a tilt will be explained by the use of the terms “right”, “left”, “forward (or front)”, “down” and “up”. These are directions as viewed from the player 11 who grips the right grip 15 of the game apparatus 1 with the right hand, and grips the left grip 13 of the game apparatus 1 with the left hand.

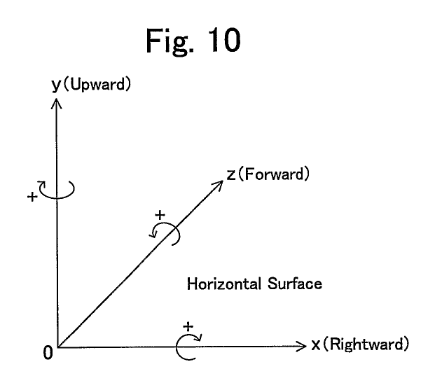

Also, a vector (hereinafter referred to as a “tilt vector”) having a start point at the center of the tilt sensor 46 is used to indicate the direction of the tilt of the tilt sensor 46 (i.e., the tilt of the substrate 44 on which the tilt sensor 46 is mounted). In addition, as shown in FIG. 10, a left-handed three dimensional coordinate system having an x-axis, a y-axis and a z-axis is considered in which the horizontal surface is in parallel with the zx-plane and perpendicular to the y-axis. Then, the direction of the positive x-axis is the rightward direction, the direction of the positive z-axis is the forward direction, and the direction of the positive y-axis is the upward direction. The start point of the tilt vector is placed on the origin of the coordinate system. Also, the tilt vector is defined to have a negative y-component (in the direction of gravity).

Also, the rotation about the x-axis is defined to be positive when rotating as y->z, the rotation about the y-axis is defined to be positive when rotating as z->x, and the rotation about the z-axis is defined to be positive when rotating as x->y.

In addition to this, a vector created by projecting the tilt vector onto the zx-plane (hereinafter referred to as the “zx-vector”) is considered. Then, the rotation angle of the zx-vector is defined as an angle measured about the y-axis to take a positive value in the counter clockwise direction and a negative value in the clockwise direction respectively from the positive x-axis which is the direction of the zx-vector corresponding to the rotation angle of zero degree.

Then, in the case of the tilt sensor 46 of the present embodiment, if the rotation angle θ of the zx-vector falls within the range defined as −45≦θ<45, the switch SWR is turned on and the values of the input/output ports IO3 to IO6 become “0010” in combination. This state is referred to as a “rightward tilt state”. If the rotation angle θ of the zx-vector falls within the range defined as 45≦θ<135, the switch SWB is turned on and the values of the input/output ports IO3 to IO6 become “0001” in combination. This state is referred to as a “front downward tilt state”.

If the rotation angle θ of the zx-vector falls within the range defined as 135≦θ<225, the switch SWL is turned on and the values of the input/output ports IO3 to IO6 become “0100” in combination. This state is referred to as a “leftward tilt state”. If the rotation angle θ of the zx-vector falls within the range defined as 225≦θ<315, the switch SWU is turned on and the values of the input/output ports IO3 to IO6 become “1000” in combination. This state is referred to as a “front upward tilt state”.

However, in order to turn on either the switch SWU, SWB, SWR or SWL, it is required in any one of the above states that the tilt sensor 46 (the substrate 44) is tilted at an angle greater than or equal to a predetermined angle (for example, 30 degrees) with respect to the horizontal surface. Accordingly, in the case where the tilt sensor 46 (the substrate 44) is not tilted at an angle greater than or equal to the predetermined angle with respect to the horizontal surface, all the switches SWU, SWB, SWR and SWL are turned off irrespective of the zx-vector, and the values of the input/output ports IO3 to IO6 become “0000” in combination. This state is referred to as a “no tilt state”.

The above operations will be explained from another view point. In the state where the tilt sensor 46 (substrate 44) is in parallel with the horizontal surface, all the switches SWU, SWB, SWR and SWL are turned off.

In the state where the tilt sensor 46 (substrate 44) is tilted to the right, the tilt sensor 46 is in the state where it is rotated in the negative direction about the z-axis. The switch SWR is turned on when the tilt sensor 46 (substrate 44) is tilted to the right in this manner at an angle greater than or equal to the predetermined angle with respect to the horizontal surface.

In the state where the tilt sensor 46 (substrate 44) is tilted to the left, the tilt sensor 46 is in the state where it is rotated in the positive direction about the z-axis. The switch SWL is turned on when the tilt sensor 46 (substrate 44) is tilted to the left in this manner at an angle greater than or equal to the predetermined angle with respect to the horizontal surface.

In the state where the tilt sensor 46 (substrate 44) is downwardly tilted to the front, the tilt sensor 46 is in the state where it is rotated in the positive direction about the x-axis. The switch SWB is turned on when the tilt sensor 46 (substrate 44) is downwardly tilted to the front in this manner at an angle greater than or equal to the predetermined angle with respect to the horizontal surface.

In the state where the tilt sensor 46 (substrate 44) is upwardly tilted to the front, the tilt sensor 46 is in the state where it is rotated in the negative direction about the x-axis. The switch SWU is turned on when the tilt sensor 46 (substrate 44) is upwardly tilted to the front in this manner at an angle greater than or equal to the predetermined angle with respect to the horizontal surface.

The processor 48 receives signals from the tilt sensor 46 as described above, i.e., the values of the input/output ports IO3 to IO6 as a tilt flag, determines the tilt of the game apparatus 1, and changes the manipulation object 88 (refer to FIG. 8 as described below) in accordance with the tilt. Also, when an “ON” signal is received from the accelerator switch 25, the processor 48 accelerates the manipulation object 88. Furthermore, when an “ON” signal is received from the right brake switch 54 and/or the left brake switch 52, the processor 48 decelerates the manipulation object 88. Still further, when an “ON” signal is received from the pause switch 27, the processor 48 stops the screen.

Although not shown in the figure, the internal configuration of the processor 48 will briefly be explained. The processor 48 includes various functional blocks such as a CPU (central processing unit), a graphics processor, a sound processor and a DMA controller, and in addition to this, includes an A/D converter for accepting analog signals and an input/output control circuit for receiving input signals from external electronic circuits and electronic elements and outputting output signals to them. The above input/output ports IO0 to IO6 are connected to this input/output control circuit.

The CPU runs a game program stored in the ROM 50, and performs various types of arithmetic operations. The graphics processor and the sound processor read image data and sound data stored in the ROM 50 in accordance with the results of the operations performed by the CPU, generate a video signal and an audio signal, and outputs them through the AV cable 9.

Furthermore, the processor 48 is provided with an internal memory, which is for example a RAM (random access memory) but not shown in the figure. The internal memory is used to provide a working area, a counter area, a resister area, a temporary data area, a flag area and/or the like.

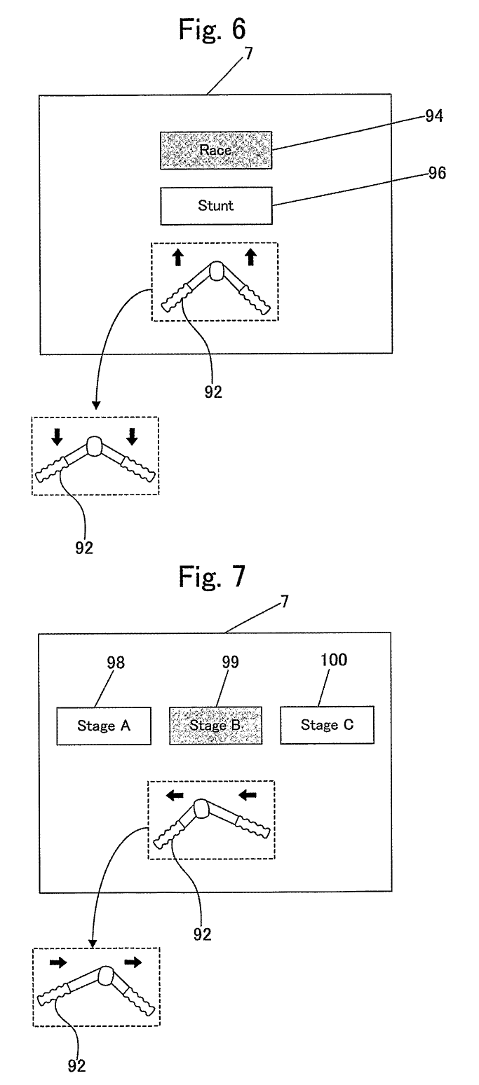

FIG. 6 is a view showing an example of a game mode selection screen (race/stunt) as displayed on the television monitor 7 of FIG. 1. As shown in FIG. 6, this screen includes a race selection object 94 for entering a race mode, a stunt selection object 96 for entering a stunt mode, and a manipulation guide 92 for guiding the manipulation of the game apparatus 1.

The race mode is a game mode for competing for the best time of the course as selected. The stunt mode is a game mode for competing on feat of driving on the course as selected. The manipulation guide 92 alternately and repeatedly shows an image indicating that the game apparatus 1 is tilted upward to the front (with upward arrows) and an image indicating that the game apparatus 1 is tilted downward to the front (with downward arrows).

When the game apparatus 1 is tilted upward to the front, the switch SWU is turned on, and the processor 48 makes the race selection object 94 selected, and when the game apparatus 1 is tilted downward to the front, the processor 48 makes the stunt selection object 96 changed in a selected state. Then, when the accelerator switch 25 is turned on, the processor 48 fixes the selection.

FIG. 7 is a view for showing an example of a game mode selection screen (stage A/B/C) as displayed on the television monitor 7 of FIG. 1. As shown in FIG. 7, this screen includes stage selection objects 98, 99 and 100, and a manipulation guide 92 for guiding the manipulation of the game apparatus 1.

The manipulation guide 92 alternately and repeatedly shows an image indicating that the game apparatus 1 is tilted to the left (with leftward arrows) and an image indicating that the game apparatus 1 is tilted to the right (with rightward arrows).

When repeating the action of tilting the game apparatus 1 to the left (turning on the switch SWL) and returning the game apparatus 1 to the horizontal state (turning off all the switches SWL, SWR, SWU and SWB), the processor 48 detects these actions, and cyclically changes the selection state of the stage selection objects as 99->98->100->99. On the other hand, when repeating the action of tilting the game apparatus 1 to the right (turning on the switch SWR) and returning the game apparatus 1 to the horizontal state (turning off all the switches SWL, SWR, SWU and SWB), the processor 48 detects these actions, and cyclically changes the selection state of the stage selection objects as 99->100->98->99. Then, when the accelerator switch 25 is turned on, the processor 48 fixes the selection.

FIG. 8 is a view for showing an example of a game screen as displayed on the television monitor 7 of FIG. 1. This game screen is provided for the stunt mode and includes a time display area 80, a point display area 82, an engine rotational speed (engine revolution number) display area 84, a course map 85, a background 90 and the manipulation object 88.

In the case of the present embodiment, since the motocross game is described as an example, the manipulation object 88 represents a rider on motocross motorcycle. The time display area 80 displays the elapsed time from the start of the manipulation object 88 to the current time in a virtual space of the screen. The point display area 82 displays the points accumulated in accordance with the actions performed by the manipulation object 88. The engine rotational speed display area 84 displays the rotational speed of an engine, which is virtual space, of the motocross motorcycle which is the manipulation object 88. The course map 85 displays the current position of the manipulation object 88 on the course of a map.

The processor 48 changes the manipulation object 88 in accordance with the input from the tilt sensor 46, i.e., the tilt of the game apparatus 1. For example, when the processor 48 determines that the game apparatus 1 is tilted downward to the front, the manipulation object 88 is displayed as if the motocross motorcycle is plunged forward. For example, when the processor 48 determines that the game apparatus 1 is tilted upward to the front, the manipulation object 88 is displayed as if the front of the motocross motorcycle is lifted. For example, when the processor 48 determines that the game apparatus 1 is tilted to the right, the manipulation object 88 is displayed as if the motocross motorcycle is oriented obliquely to the right. For example, when the processor 48 determines that the game apparatus 1 is tilted to the left, the manipulation object 88 is displayed as if the motocross motorcycle is oriented obliquely to the left.

As has been discussed above, the player 11 can manipulate the manipulation object 88 by gripping the left grip 13 and the right grip 15, and tilting the game apparatus 1 itself in air to the desired direction.

Also, when the accelerator switch 25 is turned on, the processor 48 accelerates the change of the background 90 to produce such a scene as if the manipulation object 88 is accelerated, and in addition to this, increases the rotational speed as displayed in the engine rotational speed display area 84. Furthermore, when the right brake switch 54 and/or the left brake switch 52 is turned on, the processor 48 decelerates the change of the background 90 to produce such a scene as if the manipulation object 88 is decelerated, and in addition to this, decreases the rotational speed as displayed in the engine rotational speed display area 84.

The player 11 can control the speed of the manipulation object 88 in this manner by controlling the on/off operations of the accelerator switch 25, the right brake switch 54 and the left brake switch 52.

As has been discussed above, the player 11 can manipulate the manipulation object 88 by gripping the left grip 13 and the right grip 15 to change the tilt of the game apparatus 1 itself and controlling the on/off operations of the switches 25, 52 and 54 in the same manner as if he were driving the motocross motorcycle.

Incidentally, the processor 48 can let the manipulation object 88 do a particular action by associating a particular tilt of the game apparatus 1 with a particular scene. For example, if it is determined that the game apparatus 1 is tilted to the left in the particular scene, the processor 48 lets the manipulation object 88 do the particular action. Also, the processor 48 can let the manipulation object 88 do a particular action by associating the particular action with a particular combination of a plurality of tilts of the game apparatus 1. For example, if it is determined that the game apparatus 1 is successively tilted to the left, to the right, and then upward to the front in accordance with this particular combination, the processor 48 lets the manipulation object 88 do the particular action. Furthermore, the processor 48 can let the manipulation object 88 do a particular action by associating the particular action with a combination of a particular scene and a particular combination of a plurality of tilts of the game apparatus 1. For example, if it is determined that the game apparatus 1 is successively tilted to the left, to the right, and then upward to the front in accordance with this particular combination in the particular scene, the processor 48 lets the manipulation object 88 do the particular action.

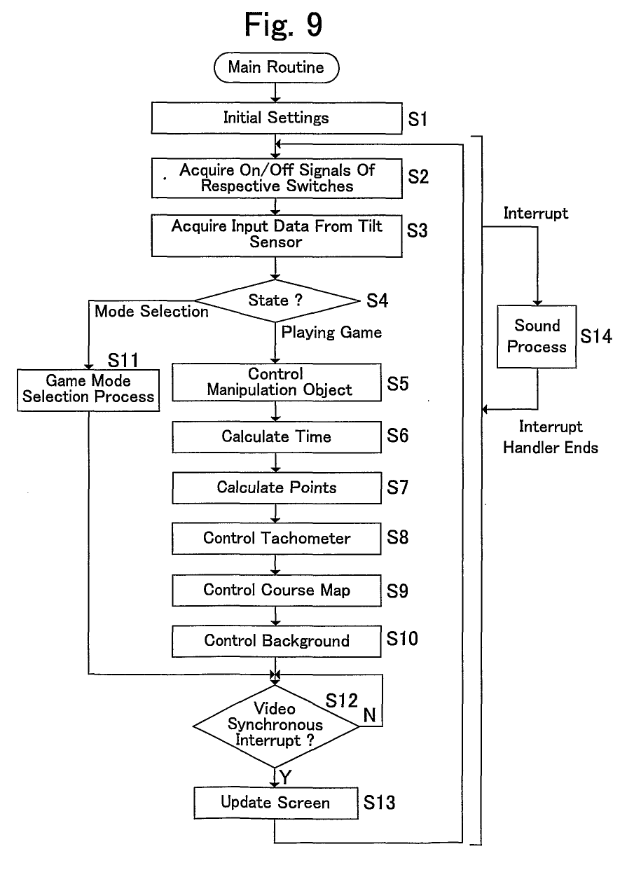

FIG. 9 is a flow chart for showing an example of the game process by the processor 48 of FIG. 5. As shown in FIG. 9, in step S1, the processor 48 performs the initial settings of the system. In step S2, the processor 48 checks the input/output ports 100 to 102, and acquires the on/off information of the switches 25, 27, 52 and 54. In step S3, the processor 48 checks the input/output ports IO3 to IO6 and acquires input data of 4 bits, “****”, from the tilt sensor 46. The processor 48 sets the tilt flag to the acquired data “****” in the internal memory. As has been discussed above, the processor 48 determines the “no tilt state” if the tilt flag is “0000”, the “rightward tilt state” if the tilt flag is “0010”, the “front downward tilt state” if the tilt flag is “0001”, the “leftward tilt state” if the tilt flag is “0100”, and the “front upward tilt state” if the tilt flag is “1000”.

In step S4, the processor 48 proceeds to either step S5 or S11 in accordance with the current state. However, the first state is a state for selecting a game mode, and the processor 48 proceeds to step S11 in which the process for selecting a game mode is performed (refer to FIG. 6 and FIG. 7).

In the state where the game is being played, the processor 48 proceeds to step S5. In step S5, the processor 48 refers to the tilt flag, and sets the manipulation object 88 to the appearance corresponding to the tilt of the game apparatus 1.

In step S6, the processor 48 calculates the elapsed time from the start for the purpose of displaying a time in the time display area 80. In step S7, the processor 48 calculates points in accordance with the action of the manipulation object 88 for the purpose of displaying the points in the point display area 82. In step S8, the processor 48 refers to the on/off information of the accelerator switch 25 and the brake switches 52 and 54, and calculates the rotational speed of the virtual engine. In step S9, the processor 48 calculates the current position of the manipulation object 88 on the map for the purpose of displaying the current position on the course map 85. In step S10, the processor 48 refers to the on/off information of the accelerator switch 25 and the brake switches 52 and 54, and calculates the velocity of changing the background 90 on the basis of this information.

In step S12, if a video system synchronous interrupt occurs (for example, at 1/60 second intervals), the processor 48 proceeds to step S13 in which the display image is updated by generating a video signal anew, and if the system is waiting for the interrupt the process repeats the same step S12. In step S13, the processor 48 performs the process of updating the screen (video frame) displayed on the television monitor 7 in accordance with the processing result in steps S5 to S11.

The sound process in step S14 is performed when a sound interrupt is issued, the processor 48 generates an audio signal, and thereby a music sound or a sound effect is outputted.

By the way, in the case of the present embodiment as has been discussed above, the game apparatus 1 itself is moved in air while the tilt of the game apparatus 1 is detected, and thereby it is possible to develop game programs which make use of the tilt of the game apparatus 1 itself. Accordingly, the player can enjoy the game while performing dynamic manipulations.

Also, in the case of the present embodiment, since the game apparatus 1 is provided with the processor 48 including the CPU, the graphics processor, the sound processor and so forth, the game can be played only by connecting the game apparatus 1 to the television monitor 7.

Furthermore, in the case of the present embodiment, the battery cells are installed in the left grip 13 and the right grip 15, the space can be effectively utilized, and thereby it is possible to optimize the size of the game apparatus 1. The optimized size is such that the player 11 can move the game apparatus 1 in air in a comfortable manner.

Meanwhile, the present invention is not limited to the above embodiments, and a variety of variations and modifications may be effected without departing from the spirit and scope thereof, as described in the following exemplary modifications.

(1) In the above description, while the game apparatus 1 is used to play the motocross game so that the appearance of the game apparatus 1 is designed to resemble the handlebar of a motorcycle, the appearance of the game apparatus 1 is not limited thereto. Needless to say, the game content is not limited to the motocross game.

(2) In the above description, while the tilt sensor 46 is used as an example for detecting a tilt, any other known method and sensor of detecting a tilt can be used in the same manner.

(3) In the above description, while the game apparatus 1 serves also as a controller which is manipulated by the player. However, it is possible to provide a separate game device incorporating the processor 48, the ROM 50 and the like which perform the data processing for playing the game and generating video/audio signals, so that only the elements such as the tilt sensor 46 serving as a controller remain in the game apparatus 1 of FIG. 2. In other words, the game apparatus 1 of FIG. 2 can be designed as a device only for inputting control signals to the separate game device.

(4) In the case of the above example, the tilt sensor 46 serves to output digital signals, i.e., on/off state signals. However, it may also be designed as a sensor (biaxial or triaxial accelerating sensor) which outputs analog signals in proportion to the tilts respectively about the x-axis, y-axis and z-axis of the coordinate system. In this case, the processor 48 can change the manipulation object 88 in accordance with the degree of the tilt about each coordinate axis. Accordingly, the player can more finely manipulate the manipulation object 88. And, it is possible to provide a gyro sensor (uniaxial to triaxial angular velocity sensor) in addition to the tilt sensor 46. In this case, the processor 48 can reflect the angular velocity signal from the gyro sensor in the motion of the manipulation object 88. Alternatively, the gyro sensor (uniaxial to triaxial angular velocity sensor) can be installed in place of the tilt sensor 46.

While the present invention has been described in terms of embodiments, those skilled in the art will recognize that the invention is not limited to the embodiments described. The present invention can be practiced with modification and alteration within the spirit and scope of the appended claims. The description is thus to be regarded as illustrative instead of limiting in any way on the present invention.

1. A game apparatus to be moved in air, comprising:
a tilt detection unit operable to detect a tilt of the game apparatus;
a housing member in which said tilt detection unit is provided;
a first cylindrical grip member to be gripped by one hand of a player; and
a second cylindrical grip member to be gripped by the other hand of the player, wherein
said first grip section and said second grip section are located respectively on the opposite sides of said housing member.

2. The game apparatus as claimed in claim 1 further comprising:
a processor operable to change a manipulation object to be displayed on a display device in accordance with the tilt of the game apparatus as detected by said tilt detection unit, wherein
said processor is located in said housing member.

3. The game apparatus as claimed in claim 1 wherein a battery box is provided in at least one of said first grip section and said second grip section.

4. The game apparatus as claimed in claim 2 wherein a battery box is provided in at least one of said first grip section and said second grip section.

5. The game apparatus as claimed in claim 1 wherein said tilt detection unit comprises four switches which are used for detecting the tilts of the game apparatus to the left, to the right, downward to the front and upward to the front respectively.

6. A controller to be moved in air and operable to output a control signal to an information processing apparatus which generates an image to be displayed on a display device, comprising:
a tilt detection unit operable to detect a tilt of the controller and output a signal indicative of the tilt to the information processing apparatus as the control signal;
a housing member in which said tilt detection unit is provided; and
a grip portion attached to the housing member or integrated with the housing member, and provided to be gripped by a hand of a player.
